(19) United States
(12) Patent Application Publication
(10) Pub. No.: US 2009/0297926 A1
(43) Pub. Date: Dec. 3, 2009

(54) Use of large format prismatic lithium-ion cells in electric vehicles

(76) Inventor: Lance Y. Liu, Middlebury, CT (US)

Correspondence Address: Lance Y. Liu, 4 Colonial Court, Middlebury, CT, 06762, US

(21) Appl. No.: 12/156,002

(22) Filed: May 29, 2008

(51) Int. Cl. H01M 10/36; H01M 2/02

(52) U.S. Cl. 429/50; 429/149; 429/163

(57) ABSTRACT

This invention is directed to a battery pack with high energy density and a large format prismatic lithium-ion cell of at least 16 squre inches, comprising (1) at least one positive electrode, (2) at least one negative electrode, (3) a non-aqueous electrolyte, and (4) a homogeneous microporous membrane which comprises (a) a hot-melt adhesive, (b) an engineering plastics, (c) optionally a tackifier and (d) a filler having an average particle size of less than about 50 μm. The resulting battery pack can be used as power source for electric vehicles to extend its ranged up to 700 miles per charge.

### FIELD OF THE INVENTION

This invention relates generally to battery packs and electrochemical cells with high energy density and their use in electrically powered automobiles.

### BACKGROUND OF THE INVENTION

Lithium-ion cell/battery has been used as the power source for many applications, such as cellular phones and notebook computers. However, the lack of technology for making cells in large format and for making the cells safe have prevented the introduction of lithium-ion cell into large format systems such as electric vehicles (EV), hybrid electric vehicles (HEV), and standby power stations. There is a need to develop large format battery cells and battery pack with high energy density.

U.S. Pat. Nos. 4,620,956; 5,667,911 and 5,691,077 have described that a lithium-ion rechargeable cell comprises a negative electrode, a positive electrode, a battery separator membrane, and a non-aqueous electrolyte. The separator membrane used for the cell has been a polyethylene “PE” or polypropylene “PP” based porous polymer membrane. The separator membrane is not able to adhere onto cell electrodes by itself. Therefore, an external pressure is usually applied by winding the separator membranes and electrodes together followed by packaging into a metal case to maintain proper contact between separator membranes and electrodes. The means of external pressure is adequate to build a good interface between separator and electrodes only for small cells e.g. cells for cellphone applications. For larger size cells such as cells with a footprint of 4 by 4 inches or an A4 paper size for potential applications such as HEV and EV, it becomes very difficult, impossible, or impractical to build a proper interface by the means of external pressure. If metal cases with the same thickness as for small cells are used, the external pressure is not high enough to hold the separator membranes and electrodes together properly, in particular, for the center area of the cell. A thicker metal case is able to provide higher external pressure to build a proper contact between separator membranes and electrodes. However, this approach may result in very poor energy density due to the additional weight contributed by the thick battery case.

Sun, U.S. Pat. No. 6,527,955, Mar. 4, 2003, discloses a novel heat-activatable microporous membrane (or bondable separator membrane). The bondable separator has the capability to be bound onto the surface of cell electrodes through heat activation. As a result, the cell has an excellent interface between the separator and electrodes.

As described in above patent, and also U.S. Pat. No. 6,815,123, Nov. 9, 2004 and U.S. Pat. No. 6,998,193, Feb. 14, 2006 to Sun, the heat-activatable separator membrane is useful in the construction of a lithium-ion battery. Small cells with a footprint of 11 square centimeter and about 16 square centimeter were made by the use of the novel separator membrane. These cells showed better performance than the cells built with conventional separator membranes, including higher rate capability, longer cycle life, lower and stable cell impedance during charge/discharge cycling.

### BRIEF SUMMARY OF THE INVENTION

One aspect of the invention is directed to a battery pack, comprising two or more large format prismatic lithium-ion cells with a specific energy of greater than 200 wh/kg which comprise (a) at least one positive electrode, (b) at least one negative electrode, (c) electrolyte, (d) a homogeneous microporous membrane which comprises (i) a hot-melt adhesive, (ii) an engineering plastics, (iii) optionally a tackifier and (iv) a filler having an average particle size of less than about 50 μm, and (v) a battery cell case; wherein said large format prismatic lithium-ion cell has a footprint of at least 16 square inches.

Another aspect of the invention is directed to a method of using new battery packs in automobile to extend the driving range of said automobile to at least 250 miles per charge, wherein said battery packs account for about 25% to about 50% of the total weight of said automobile, wherein each of the new battery pack comprises two or more large format prismatic lithium-ion cells with a specific energy of greater than 200 wh/kg which comprise (a) at least one positive electrode, (b) at least one negative electrode, (c) electrolyte, (d) a homogeneous microporous membrane which comprises (i) a hot-melt adhesive, (ii) an engineering plastics, (iii) optionally a tackifier and (iv) a filler having an average particle size of less than about 50 μm, and (v) a battery cell case; wherein said large format prismatic lithium-ion cell has a footprint of at least 16 square inches.

A further aspect of the invention is directed to a lithium-ion cell which is between about 16 square inches and about 2500 square inches, comprising (1) at least one positive electrode, (2) at least one negative electrode, (3) an electrolyte, (4) a homogeneous microporous membrane which comprises (a) a hot-melt adhesive, (b) an engineering plastics, (c) optionally a tackifier and (d) a filler having an average particle size of less than about 50 μm, and (5) a battery cell case.

The contents of the patents and publications cited herein and the contents of documents cited in these patents and publications are hereby incorporated herein by reference to the extent permitted.

### BRIEF DESCRIPTION OF THE DRAWINGS

FIG. 1 is top plan view of a large format prismatic lithium-ion cell of this invention.

FIG. 2 is an end view of the cell shown in FIG. 1.

FIG. 3 is a graph showing the discharge profile of cell No. E-04 when discharged at a constant current of 1.0 A to a cut-off voltage of 2.5V.

FIG. 4 shows the charge (solid line) and discharge profiles (line with circle) of one section of the battery pack.

### DETAILED DESCRIPTION

The battery pack and the large format prismatic lithium-ion cells of this invention have key advantages over conventional prismatic or cylindrical cells. They have not only higher energy density specific energy, but also substantially lower possibility of battery failure due to a “hot” cell problem when the cells are used for assembling battery packs. They also have improved safety features such as a lower thermal shut-down temperature.

In a preferred embodiment, the battery or battery pack is made by assembling several large format prismatic lithium-ion cells in series to add up voltage, or in parallel to increase capacity. For instance, when two lithium-ion cells, each having a 3.7V and a capacity of 4.5V, are assembled together in series, the resulting battery has a doubled voltage (7.2V) and a same capacity of 4.5 Ah. If these two cells are assembled in parallel, the resulting battery has a double capacity (9.0 Ah) and a same voltage of 3.7V.

In one preferred embodiment of the battery pack, the large format prismatic lithium-ion cell has a footprint of at least 16 square inches, more preferably a footprint of at least 25 square inches or at least 36 square inches, even more preferably a footprint of at least 49 square inches or at least about 400 square inches, even more preferably a footprint of from about 16 square inches to about 2500 square inches and the most preferably a footprint of from about 400 square inches to about 1600 square inches. Preferably, the battery cell case is made of aluminum foil-laminated plastic film, the positive electrode is a lithium-ion positive electrode, the negative electrode is a lithium-ion negative electrode and the electrolyte is a lithium-ion electrolyte, more preferably a liquid lithium-ion electrolyte or a polymer lithium-ion electrolyte.

The negative electrode is usually made of carboneous material such as coke, MCMB, or graphite. The positive electrode can be made of lithium compounds such as LiCoO₂, LiNiO₂, LiMn₂O₄, LiFePO₄, and LiCoₓNi₁₋ₓO₂ wherein the x is from 0.1 to 0.9. However, any electrode materials known in the art can be used herein.

The liquid lithium-ion electrolyte is preferably a non-aqueous electrolyte, which usually comprises: (1) an electrolyte salt, and (2) a non-aqueous solvent. Examples of these electrolyte salts include LiPF₆, LiBF₄, LiAsF₆, LiCl₄, LiN(SO₂CF₃)₂, lithium perfluoro-sulfonates. Examples of non-aqueous solvent is include ethylene carbonate “EC”, propylene carbonate “PC”, diethyl carbonate “DEC”, dimethyl carbonate “DMC”, ethyl methyl carbonate “EMC”, γ-butyrolactone “γ-BL”, methyl acetate “MA”, methyl formate “MF”, and dimethyl ether “DME”, and solvents described in U.S. patent application Ser. No. 10/731,268, the contents of which are incorporated herein by reference to the extent permitted.

The positive electrode and the negative electrode are separated by at least one heat-activatable microporous membrane as described in U.S. Pat. No. 6,527,955, Mar. 4, 2003; U.S. Pat. No. 6,998,193, Feb. 14, 2006, to Sun, the contents of which are incorporated herein by reference.

In another preferred embodiment, the large format prismatic lithium-ion cell has a thickness of from about 1 mm to about 10 mm. Preferably, the large format lithium-ion cell has a specific energy density of greater than 200 wh/kg, more preferably greater than 210 wh/kg and the most preferably about 220 wh/kg.

In another embodiment, the large format lithium-ion cell has an energy density of at least 450 wh/L, preferably at least 500 wh/L, more preferably at least 510 wh/L and the most preferably at least 520 wh/L.

In a further preferred embodiment, the battery packs are used to power an electric vehicle to an extend driving range of at least 250 miles per charge with the battery packs account for about 25% to about 50% of the total weight of the electric vehicle. Preferably, the driving range of the electric vehicle is extended to at least 300 miles per charge or at least 350 miles per charge. More preferably, the driving range of the electric vehicle is extended to at least about 400 miles per charge or at least about 450 miles per charge. More preferably the driving range of the electric vehicle is extended to at least about 500 miles per charge or at least about 550 miles per charge. Even more preferably, the driving range of the electric vehicle is extended to at least about 600 miles per charge or at least about 650 miles per charge. The most preferably, the driving range of the electric vehicle is extended to at least about 700 miles per charge.

In a further preferred embodiment, the lithium-ion cell is between about 16 square inches and about 2500 square inches, comprising (1) at least one positive electrode, (2) at least one negative electrode, (3) an electrolyte, (4) a homogeneous microporous membrane which comprises (a) a hot-melt adhesive, (b) an engineering plastics, (c) optionally a tackifier and (d) a filler having an average particle size of less than about 50 μm, and (5) a battery cell case. Preferably, the lithium-ion cell is between about 25 square inches and about 1600 square inches and more preferably between about 1600 square inches to about 2500 square inches.

As used herein, the terms “separator membrane”, “bondable separator membranes”, “heat-activatable microporous membrane”, and “homogeneous microporous membrane” are used interchangeably.

As used herein, the term “cell” or “battery cell” means an electrochemical cell made of at least one positive electrode, at least one negative electrode, an electrolyte, and a separator membrane. The term “cell” and “battery cell” are used interchangeably. The “battery” or “battery pack” means an electric storage device made of more than two cells. The terms “battery” and “battery pack” are used interchangeably.

The battery cell case is preferably made with aluminum foil-laminated plastic film, which has a thickness of from about 20 μm to about 200 μm. More preferably, the aluminum foil-laminated plastic film has a thickness of from about 30 μm to about 100 μm. Most preferably, aluminum foil-laminated plastic film has a thickness of from about 40 μm to about 50 μm.

Preferably, the large format prismatic lithium-ion cell has footprint of at least 25 square Inches, more preferably at least 36 square inches, even more preferably at least 49 square inches and the most preferably at least about 400 square inches.

In a preferred embodiment, the large format prismatic lithium-ion cell of this invention has a thickness of from about 1 mm to about 10 mm. More preferably, the cell has a thickness of from about 3 mm to about 6 mm.

In another preferred embodiment, the binding of separator membranes onto electrodes is achieved by pressing under a pressure of from 50 to about 250 psi (3.5-17.4 kg/cm²) at a temperature of from about 60 to about 125° C. for a period of about 0.1-100 minutes, preferably from about 1 to about 10 minutes.

An important utility for the large format prismatic lithium-ion cell is in the assembly of large battery packs to be used as the power source for applications such as electric vehicles (EV), hybrid electric vehicles (HEV), power-assist HEV (P-HEV), and standby power stations.

Large format prismatic cell offers high energy density and has the advantage of less battery (pack) failure due to a “hot cell”. A battery pack is usually assembled with many cells in series as well as in parallel. In case one cell has a problem such as lower capacity or higher internal resistance, the whole battery pack becomes bad, which may no longer be used. The problem cell is the so-called “hot cell”.

Table 1 gives an example for assembling 42V/700 Wh battery for Power-Assist HEV (P-HEV) application using three types of lithium-ion cells. These are 1) 18650 cylindrical cells which have been widely used for making battery packs to power notebook computers, 2) a prismatic cell with a footprint of 4 by 4 inches, made by Policell Technologies, and 3) a prismatic cell with a even larger footprint, 8×11 inches. As shown in table 1, 84 pieces of 18650 cylindrical cells are needed to assemble one 42V battery. The number of cells needed for one 42V battery reduces to 48 if cells with a footprint of 4 by 4 inches are used. With the use of cells of 8 by 11 inches, only 12 cells are needed to assemble one 42V battery.

If we use the possibility of battery failure for the battery of 8 by 11 inches as the comparison and assign it a number 1, the possibility of failure due to a “hot” cells for the 4′ by 4′ cells and the 18650 cylindrical cells would be 4 and 7, respectfully.

TABLE 1

| | | | | | No. of | |
|---|---|---|---|---|---|---|
| | | Foot-print | Thickness | Capacity/ | cells for a | Possibility |
| | Cell | of cell | of cell | Energy | 42 V | of battery |
| Type of cell | configuration | (inch) | (mm) | (Ah/Wh) | battery | failure |
| 18650 | cylindrical | Length: | Φ18 mm | 2.4/8.9 | 84 | 7 |
| | | 65 mm | | | | |
| PLB33105102 | prismatic | 4′ × 4′ | 3.3 | 4.7/17.4 | 48 | 4 |
| PLB33216280 | prismatic | 8 × 11′ | 3.3 | 27.5/101.8 | 12 | 1 |
| | | | | (projected) | | |

The following examples are given as specific illustrations of the invention. It should be understood, however, that the invention is not limited to the specific details set forth in the examples. All parts and percentages in the examples, as well as in the remainder of the specification, are by weight unless otherwise specified.

Further, any range of numbers recited in the specification or paragraphs hereinafter describing or claiming various aspects of the invention, such as that representing a particular set of properties, units of measure, conditions, physical states or percentages, is intended to literally incorporate expressly herein by reference or otherwise, any number falling within such range, including any subset of numbers or ranges subsumed within any range so recited. The term “about” when used as a modifier for, or in conjunction with, a variable, is intended to convey that the numbers and ranges disclosed herein are flexible and that practice of the present invention by those skilled in the art using temperatures, concentrations, amounts, contents, carbon numbers, and properties that are outside of the range or different from a single value, will achieve the desired result, namely, a microporous membrane and method for preparing such membrane as well as a battery comprising the membrane.

### EXAMPLE 1

### Cell Preparation and Testing

A large format prismatic lithium-ion cell was assembled using a graphite negative electrode, a LiCoO₂ positive electrode, and a bondable separator membrane. Into the assembled battery case, was injected a non-aqueous electrolyte. Both negative and positive electrodes were conventional liquid lithium-ion battery electrodes, namely negative and positive materials are double-side coated onto copper and aluminum foil respectively, the carbon negative electrode containing about 90% graphite active material, the LiCoO₂ positive electrode containing about 91% active material.

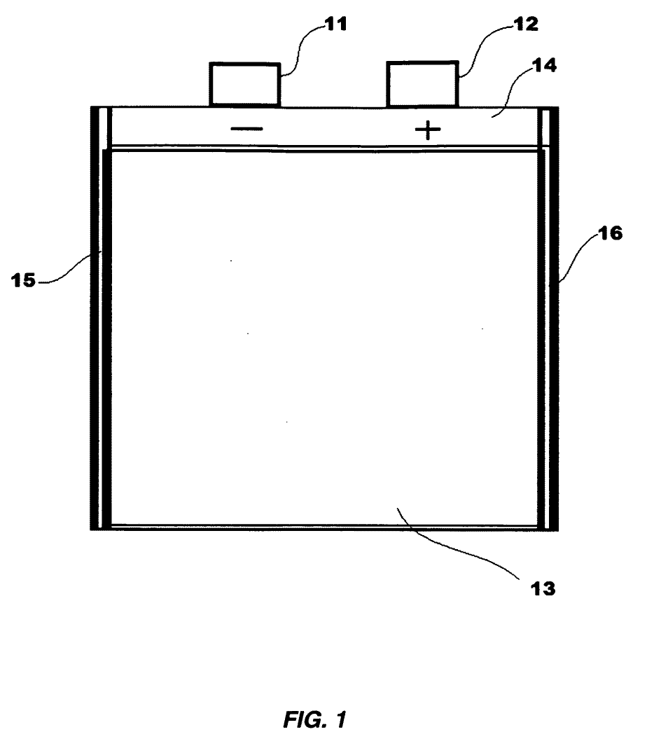

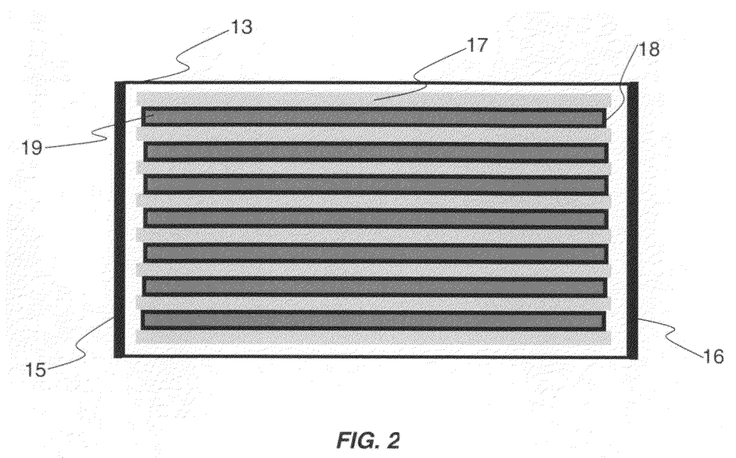

A large format prismatic lithium-ion cell, Cell No. E-01, was assembled as shown in FIG. 1 and FIG. 2 by, a) wrapping seven pieces positive electrode 19 having a size of 90 mm by 99 mm with a bondable separator membrane 18 with a dimension of 94 mm by 202 mm, b) stacking these seven pieces separator wrapped positive electrodes and eight pieces negative electrodes 17 having a size of 93 mm by 102 mm starting with negative electrode on bottom first then positive electrode, 2^{nd} negative and 2^{nd} positive in this alternative sequence, and ended with the 8^{th} negative electrode on top.

The resulting stacked cell assembly was then subjected to a step of heat-activation by pressing at 100° C. under a pressure of 109 psi for 3 minutes. After such a “dry-press” step, separator membranes bound onto electrodes firmly and the cell assembly became a stiff single piece.

These eight negative electrode leads were welded to a negative cell terminal 11 made of copper foil with a size of 10 mm by 40 mm. While seven positive electrode leads were welded to a positive cell terminal 12, which was made of aluminum foil 10 mm by 40 mm.

The cell assembly was then packaged in a cold-formed battery cell case 13, which was made with aluminum foil-laminated plastic film produced by Dai Nippon Printing Co. of Shinjuku-ku, Tokyo, Japan. Then sealed terminal side 14 and one side 15 of the cell case using a heat sealer. After the cell was fully dried, it was transferred into a dry-box under nitrogen atmosphere. Substantially about 14 g of electrolyte were injected into the cell. The cell was finally hermetically sealed by heat-sealing the last open side 16, rested for one day, and then subjected to charge/discharge cycle test. The charge/discharge cycle test was conducted using a Battery Tester Model Series 4000 manufactured by Maccor Inc. of Tulsa, Okla. Data concerning this large format cell, cell # E-01, are set forth in Table 2.

This cell delivered a discharge capacity of 3,657.4 mAh. The cell has an external dimension of 105 mm by 102 mm, i.e. about 4 by 4 inches.

### COMPARATIVE EXAMPLE 1

This example is shown in Table 2, Cell No. CE-1, which was prepared using the same materials and the same procedure as described in Example 1 except skipping the “dry-press” step. Without the “dry-press” step for binding separators onto electrodes, the resulting cell assembly was lose rather than a stiff single piece as Example E-01. To hold the cell assembly # CE-01 together, Kapton® adhesive tapes were used to wrap the cell assembly twice at the head and foot positions.

The testing results of this cell, No. CE-01, are set forth in Table 2. The cell showed a capacity of 3,188.3 mAh, which is 12.8% lower than that of Cell No. E-01, and also showed lower rate capability (83.9% vs. 96.4%) because its poor interface between separator membranes and electrodes.

TABLE 2

| | | Discharge | Rate capability |
|---|---|---|---|
| | “Dry-press” | capacity | at 1C rate |
| Cell No. | (° C./psi/min) | (mAh) | (%) |
| E-01 | 100/109/3 | 3,657.4 | 96.4 |
| CE-01 | none | 3,188.3 | 83.9 |

### EXAMPLES 2-5

As summarized in Table 3, four large format prismatic lithium-ion cells, Cell Nos. E-02 through E-05, were prepared in the same manner as described in Example 1 except using one additional pair of electrodes and also slightly larger electrodes.

Cells Nos. E-02 through E-05 were assembled with 8 units/pairs of basic cells: 8 double-side coated positive electrode 91 mm by 100 mm, 7 double-side coated negative electrodes 94 mm by 103 mm, and 2 single-side coated negative electrodes which were assembled on the top and bottom of the cell.

Testing results of these four cells are summarized in Table 3 including discharge capacity, weight of cells, specific energy, and energy density.

All these fours cells have the same external dimension of 3.3 (Thickness)×105(Width)×100 mm (Length), namely the cells with a footprint of about 4 by 4 inches. They delivered a capacity of about 4.8 Ah when discharged at a constant current of 1,000 mA to a cut-off voltage of 2.5V.

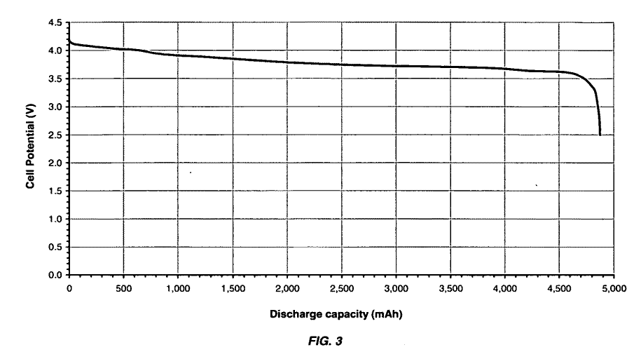

FIG. 3 shows discharge profile of cell No. E-04 when discharged at a constant current of 1,000 mA to a cut off voltage of 2.5V.

These cells Nos. E-02 through E-05 showed a specific energy of 214-219 wh/kg and an energy density of about 520 wh/L.

TABLE 3

| | Discharge | Weight | Specific | Energy |
|---|---|---|---|---|
| | capacity | of cells | energy | density |
| Cell No. | (mAh) | (g) | (wh/kg) | (wh/L) |
| E-02 | 4,839.7 | 82.4 | 217.3 | 517.5 |
| E-03 | 4,790.4 | 82.6 | 214.6 | 512.3 |
| E-04 | 4,874.7 | 82.6 | 218.4 | 521.3 |
| E-05 | 4,889.7 | 82.6 | 219.0 | 522.9 |

### EXAMPLE 6

### Assembly of Battery Pack

Sixteen large format prismatic lithium-ion cells were made in the same manner as described in Examples 2-5. Then these sixteen cells were used to assemble one battery pack.

The battery pack consists of 2 sections or modules. Each section was assembled using above 8 cells in the configuration of 4S2P, namely 4 cells in series, and the resulting 2 units made of 4 cells in series were then assembled in parallel.

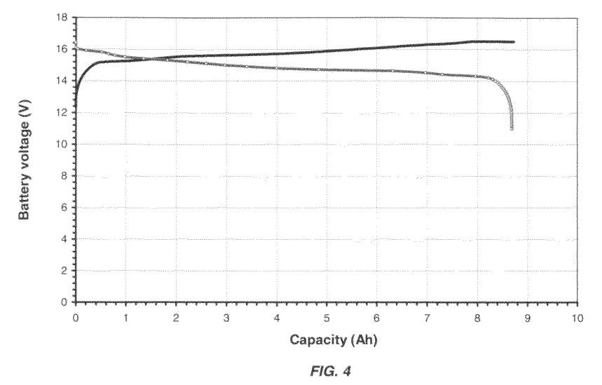

The battery pack weighs about 1.5 kg, and has an external dimension of 112.5×127.0×63.0 mm. FIG. 4 shows the charge (solid line) and discharge profiles (line with circle) of one section of the battery (Section I). Each section was made of 8 cells in the configuration of 4S2P. This section of the battery was charged at a constant current of 2.0 A up to 16.5V, and then charged continuously under constant voltage until the current dropped to below 0.3 A. It was then discharged at a constant current of 2.0 A down to a cut-off voltage of 11V.

This section of the battery delivered a discharge capacity of 8.69 Ah. The other section of this battery, Section II, showed the same capacity when charged and discharged in the same manner as for Section I.

These two sections of the battery can be operated independently or by combining them together. By combining the two sections in series, the battery offered a capacity of about 8.69 Ah with a doubled voltage of 28V (33-22V). While, by combining these two sections together in parallel, the battery delivered a doubled capacity (about 17.38 Ah) and with a voltage of 14V (16.5-11V).

When Section I of the battery described above was charges at a constant current of 2.0 A and up to a cut-off voltage of 16.8 C, namely 4.2V for each individual cell which has been widely used in the industry, this section delivered a discharge capacity about 9.5Ah. Since the battery has a weight of 1.5 kg and a volume of 0.9 litter, the specific energy and energy density of the battery are calculated to be 187.5 wh/kg and 312.4 wh/L.

### EXAMPLE 7

### Assembly of the Battery Pack on a 2007 Toyota Prius

Sixty four hundred large format prismatic lithium-ion cells (4 by 4 inches) are made in the same manner as described in Examples 2-5. Then these sixty four hundred cells are used to assemble one battery pack of about 580 kg in weight. The batter pack made to fit the 2007 Toyota Prius and is installed on the Toyota Prius to replace its current battery and its gas engine. When the pattery pack is fully charged, it powers the Toyota Prius for about 500 miles before it needs a recharge.

### EXAMPLE 8

### Assembly of the Battery Pack on 2007 Ford Escape Hybrid

Two hundred fifty large format prismatic lithium-ion cells (24 by 24 inches) are made. Then these cells are used to assemble one battery pack of about 800 kg in weight. The battery pack is made to fit on the 2007 Ford Escape Hybrid and is installed on the 2007 Ford Escape to replace to gas engine and its current battery pack. With one full charge, the 2007 Ford Escape runs on electricity only for at least 550 miles.

### EXAMPLE 9

### Assembly of the Battery Pack and an Electric Motor on a 2001 Toyota Corolla Sedan

Two hundred fifty large format prismatic lithium-ion cells (400 square inches) are made. Then these cells are used to assemble one battery pack which, together with an electric motor, replaces the gas engine of a 2001 Toyota Corolla. After the battery is fully charged, the 2001 Toyota Corolla runs solely on electricity for at least 550 miles.

### EXAMPLE 10

### Assembly of the Battery Pack and an Electric Motor on a 2003 Toyota Highlander

Two hundred fifty large format prismatic lithium-ion cells (800 square inches) are made. Then these two hundred fifty cells are used to assemble one battery pack which, together with an electric motor, replaces the gas engine of a 2003 Toyota Highlander. When fully charged, the 2003 Toyota Highlander runs solely on electricity for 600 miles.

The principles, preferred embodiments, and modes of operation of the present invention have been described in the foregoing specification. The invention which is intended to be protected herein, however, is not to be construed as limited to the particular forms disclosed, since these are to be regarded as illustrative rather than restrictive. Variations and changes may be made by those skilled in the art, without departing from the spirit of the invention.

What is claimed is:

1. A battery pack, comprising two or more large format prismatic lithium-ion cells with a specific energy of greater than 200 wh/kg which comprise
(a) at least one positive electrode,
(b) at least one negative electrode,
(c) electrolyte,
(d) a homogeneous microporous membrane which comprises
(i) a hot-melt adhesive,
(ii) an engineering plastics,
(iii) optionally a tackifier and
(iv) a filler having an average particle size of less than about 50 μm, and
(e) a battery cell case;
wherein said large format prismatic lithium-ion cell has a footprint of at least 16 square inches.

2. The battery pack of claim 1, wherein said large format prismatic lithium-ion cell has a footprint of at least 25 square inches.

3. The battery pack of claim 1, wherein said large format prismatic lithium-ion cell has a footprint of at least 36 square inches.

4. The battery pack of claim 1, wherein said large format prismatic lithium-ion cell has a footprint of at least 49 square inches.

5. The battery pack of claim 1, wherein said large format prismatic lithium-ion cell has a footprint of at least about 400 square inches.

6. The battery pack of claim 1, wherein said large format prismatic lithium-ion cell has a footprint of from about 16 square inches to about 2500 square inches.

7. The battery pack of claim 1, wherein said large format prismatic lithium-ion cell has a footprint of from about 400 square inches to about 1600 square inches.

8. A method of using the battery packs of claim 1 to power an automobile to an extend driving range of at least 250 miles per charge, wherein said battery packs account for about 25% to about 50% of the total weight of said automobile.

9. The method of claim 8, wherein said driving range of said automobile is extended to at least 300 miles per charge.

10. The method of claim 8, wherein said driving range of said automobile is extended to at least 350 miles per charge.

11. The method claim 8, wherein said driving range of said automobile is extended to at least about 400 miles per charge.

12. The method of claim 8, wherein said driving range of said automobile is extended to at least about 450 miles per charge.

13. The method of claim 8, wherein said driving range of said automobile is extended to at least about 500 miles per charge.

14. The method of claim 8, wherein said driving range of said automobile is extended to at least about 550 miles per charge.

15. The method of claim 8, wherein said driving range of said automobile is extended to at least about 600 miles per charge.

16. The method of claim 8, wherein said driving range of said automobile is extended to at least about 650 miles per charge.

17. The method of claim 8, wherein said driving range of said automobile is extended to at least about 700 miles per charge.

18. A lithium-ion cell which is between about 16 square inches and about 2500 square inches, comprising (1) at least one positive electrode, (2) at least one negative electrode, (3) an electrolyte, (4) a homogeneous microporous membrane which comprises (a) a hot-melt adhesive, (b) an engineering plastics, (c) optionally a tackifier and (d) a filler having an average particle size of less than about 50 μm, and (5) a battery cell case.

19. The lithium-ion cell of claim 18, wherein said lithium-ion cell is between about 25 square inches and about 1600 square inches.

20. The lithium-ion cell of claim 18, wherein said lithium-ion cell is between about 1600 square inches to about 2500 square inches.
